(19) United States
(12) Patent Application Publication
(10) Pub. No.: US 2018/0164765 A1
(43) Pub. Date: Jun. 14, 2018

(54) SERVICE CONTROL DEVICE, SERVICE CONTROL METHOD AND RECORDING MEDIUM

(71) Applicant: NEC CORPORATION, Tokyo (JP)

(72) Inventor: Kosuke NISHIHARA, Tokyo (JP)

(73) Assignee: NEC CORPORATION, Tokyo (JP)

(21) Appl. No.: 15/577,820

(22) PCT Filed: Jun. 10, 2016
(86) PCT No.: PCT/JP2016/002815

§ 371 Date: Nov. 29, 2017

(30) Foreign Application Priority Data
Jun. 11, 2015 (JP) 2015-118197

(51) Int. Cl. G05B 19/04

(52) U.S. Cl. CPC G05B 19/0415; G05B 2219/23287

(57) ABSTRACT

A service control device includes a controller that receives one of an external request and an execution result of a functional element and directs a functional element to be carried out next by referring to a control list holding a plan of combination of functional elements; an execution unit configured to carry out the functional element directed by the controller; a monitoring and recording unit configured to monitor an execution state of a functional element and record; and an activation level calculating unit configured to calculate an activation level of a functional element based on the execution state of a functional element having been recorded and update the control list based on the activation level.

### TECHNICAL FIELD

The disclosed subject matter relates to a service control device, a service control method and a recording medium.

### BACKGROUND ART

Utilization of big data and efforts toward Internet of Things (IoT) are attracting attention, such as collecting information on the real world to find buried values and providing service appropriate for an environment or an individual and the like. In order to collect information widely from an actual environment, a function of an edge node with a sensing device becomes important. In such the edge node, it is necessary to have not only a single information collection function but also a plurality of information collection function and to perform advanced information processing in the edge node side.

However, resources on the edge node tend to be generally limited. A battery capacity, a computing capability and a data transfer capability provided in the edge node remain low compared with a cloud, and it is difficult to perform information processing which used to be performed in the cloud side conventionally, at an edge node just as it is. For this reason, it has been devised to perform advanced information processing in an edge node having a resource limit by omitting part of processing and performing offloading to another node. For example, it is such as realizing service by a combination of a plurality of service functional elements and selecting an arrangement and combination of the functional elements. PTL 1 discloses a method to perform service by arranging a processing function in a plurality of nodes. PTL 2 discloses a method to perform offloading of part of a processing function to another node.

### CITATION LIST

### Patent Literature

### [PTL 1] Japanese Patent Application Laid-Open No. 2006-171921

[PTL 2] Published Japanese translation of PCT application No. 2002-517855

### [PTL 3] Japanese Patent Application Laid-Open No. 2010-268346

### [PTL 4] Japanese Patent Application Laid-Open No. 1995-295917

### SUMMARY OF INVENTION

### Technical Problem

It is thinkable that the most suitable combination of functional elements is different for each of a plurality of edge nodes deployed in the field. However, in PTL 1 and PTL2, a degree of necessity of a functional element suitable for the environment of each node has not been considered. For this reason, depending on the environment of each node, there has been an issue that the response time of service to be provided is long, and a processing time and resource consumption are large.

The disclosed subject matter has been made in order to settle such issue, and its object is to provide a service control device, a service control method and a recording medium that can shorten the response time of service to be provided and save processing time and resource consumption.

### Solution to Problem

A service control device according to the disclosed subject matter includes a control means for receiving one of an external request and an execution result of a functional element and directing a functional element to be carried out next by referring to a control list holding a plan of combination of functional elements; an execution means for carrying out the functional element directed by the control means; a monitoring and recording means for monitoring an execution state of a functional element and recording; and an activation level calculating means for calculating an activation level of a functional element based on the execution state of a functional element having been recorded and updating the control list based on the activation level.

A service control method according to the disclosed subject matter includes determining a functional element to be carried out next in response to one of an external request and an execution result of a functional element by referring to a control list holding a plan of combination of functional elements; carrying out the functional element to be carried out next having been determined; monitoring an execution state of a functional element and recording; calculating an activation level of a functional element based on the recorded execution state of the functional element, and updating the control list based on the activation level.

### Advantageous Effects of Invention

According to the disclosed subject matter, a service control device, a service control method and a recording medium that can shorten the response time of service to be provided and save processing time and resource consumption can be provided.

### BRIEF DESCRIPTION OF DRAWINGS

FIG. 1 is a block diagram illustrating a configuration of a service control device according to a first example embodiment of the disclosed subject matter.

FIG. 2 is a diagram illustrating an example of a plan of combination of functional elements held by a control list according to the first example embodiment of the disclosed subject matter.

FIG. 3 is a graph illustrating an example of comparison of an average execution time between plans 1 and 2 according to the first example embodiment of the disclosed subject matter.

FIG. 4 is a flow chart illustrating processing of a service control device according to the first example embodiment of the disclosed subject matter.

FIG. 5 is a block diagram illustrating a configuration of a service control device according to a second example embodiment of the disclosed subject matter.

FIG. 6 is a diagram illustrating an example of a plan of combination of functional elements held by a control list according to the second example embodiment of the disclosed subject matter.

FIG. 7 is a flow chart illustrating processing of a service control device according to the second example embodiment of the disclosed subject matter.

FIG. 8 is a block diagram illustrating a hardware exemplary configuration of a general computer.

FIG. 9 is a diagram illustrating an example of a plan of combination of functional elements held in a control list according to an example embodiment of the disclosed subject matter.

FIG. 10 is a diagram illustrating an example of a plan of combination of functional elements held in a control list according to an example embodiment of the disclosed subject matter.

### DESCRIPTION OF EMBODIMENTS

### First Example Embodiment

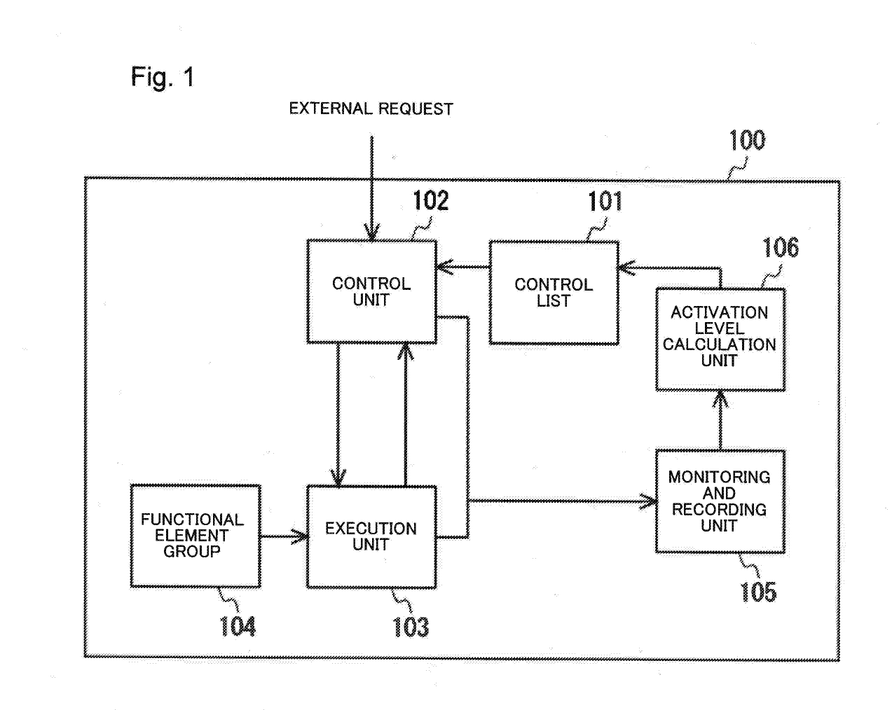

First, a configuration of a service control device 100 according to a first example embodiment of the disclosed subject matter will be described using FIG. 1. For example the service control device 100 is equipped with sensing devices in an edge node. The service control device 100 includes a control list 101, a control unit 102, an execution unit 103, a functional element group 104, a monitoring and recording unit 105 and an activation level calculation unit 106.

The control list 101 holds a plan of combination of functional elements. The plan of combination of functional elements held by the control list 101 will be described detail later.

The control unit 102 receives an external request and an execution result of a functional element by the execution unit 103. The external request means a request for execution of a functional element from outside or a request for execution of service constituted of a plurality of functional elements from outside. Also, the external request includes an external request which occurs in the node having the service control device 100 and an external request which occurs in another node. A received external request and an execution result of a functional element by the execution unit 103 are called an input signal to the control unit 102. The control unit 102 refers to the control list 101, and determines a functional element to be carried out next in response to an input signal to the control unit 102. It will be described in detail later about a method by which the control unit 102 determines a functional element to be carried out next. Further, the control unit 102 supplies a direction of a functional element to be executed next to the execution unit 103.

Next, the execution unit 103 receives the direction of a functional element to be executed next from the control unit 102. The functional element group 104 stores a plurality of functional elements. Next, the execution unit 103 selects a functional element to be carried out next from the functional element group 104 based on the direction of a functional element to be executed next. The execution unit 103 carries out the selected functional element. The execution unit 103 outputs an execution result of the functional element to the control unit 102.

The monitoring and recording unit 105 monitors and records a situation of the functional element executed by the execution unit 103. For example, the execution state of a functional element is information on such as an execution result of the functional element, an execution time of the functional element and whether a specific functional element has been carried out. Meanwhile, information on an execution result of a functional element and whether a specific functional element has been carried out is information required to calculate an execution frequency of a specific functional element as an activation level of the functional element, for example, and thus at least either one of them should be watched and recorded. The monitoring and recording unit 105 outputs the recorded execution state of the functional element to the activation level calculation unit 106.

Description will be made about monitoring and recording information on whether a specific functional element has been carried out. The monitoring and recording unit 105 monitors whether a specific functional element out of combinations of a plurality of functional elements which starts with the control unit 102 receiving an external request or an execution result of a functional element has been carried out. The monitoring and recording unit 105 records in association correlating it with an external request whether the specific functional element has been carried out. The monitoring and recording unit 105 may correlate whether a specific functional element has been carried out with a functional element carried out before carrying the specific functional element, and record it. In any case, as to one external request, information which can identify whether or not the specific functional element has been carried out is recorded. Meanwhile, the monitoring and recording unit 105 may detect, by monitoring either the control unit 102 or the execution unit 103, that the control unit 102 has received an external request or that a functional element to be carried out in advance of a specific functional element has been carried out.

The activation level calculation unit 106 receives an execution state of a functional element from the monitoring and recording unit 105. Also, the activation level calculation unit 106 calculates an activation level of the functional element based on the execution state of the functional element. As an activation level of a functional element, the activation level calculation unit 106 calculates an execution frequency of a specific functional element, for example.

It will be explained that an execution frequency of a specific functional element is calculated based on information on whether the specific functional element has been carried out. The monitoring and recording unit 105 records, as to one external request, information which can identify whether or not the specific functional element has been carried out, as information on whether or not the specific functional element has been carried out. The activation level calculation unit 106 receives the information and determines whether or not the specific functional element has been carried out for each external request. Then, the activation level calculation unit 106 calculates an execution frequency of the specific functional element from the number of times of external requests and the number of times of carrying out the specific functional element. Alternatively, the monitoring and recording unit 105 records the number of times of external requests and such information of the number of times of carrying out the specific functional element, and the activation level calculation unit 106 receives the information and calculates an execution frequency of the specific functional element.

The activation level calculation unit 106 determines whether the control list 101 is updated or not based on the calculated activation level of a functional element. Determination of whether the control list 101 is updated may be performed by determination of, for example, whether the activation level of a functional element exceeds a predetermined threshold value. For example, it may be performed by calculating an average execution time of a plan of combination of functional elements using activation levels of the functional elements and execution times of the functional elements, and determining whether the average execution time becomes short by update of the control list 101 or not.

Further, when it has been determined that the control list 101 is updated, the activation level calculation unit 106 updates the control list 101. In other words, the plan of combination of functional elements which the control list 101 holds is changed. Processing of the activation level calculation unit 106 will be described in detail later.

In the service control device 100 according to the example embodiment 1 of FIG. 1, by calculating an activation level of a functional element based on an execution state of the functional element, and updating the control list 101 based on the activation level, combination of functional elements suitable for the environment in which the node including the service control device 100 is arranged can be realized, and shortening of the response time of provided service and saving of a processing time and resource consumption can be made.

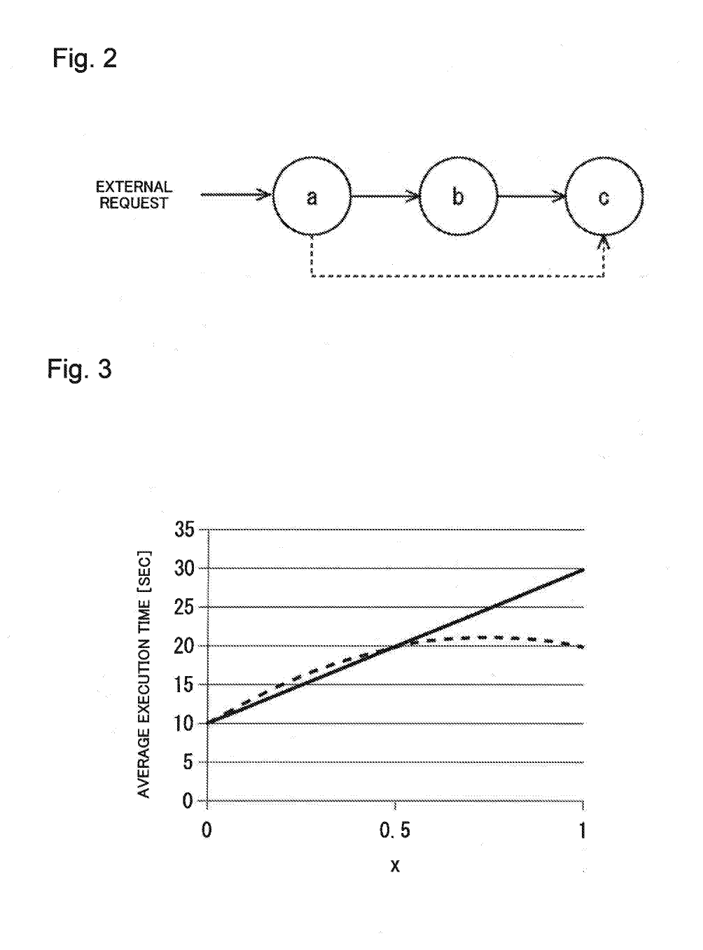

Next, a plan of combination of functional elements held in the control list 101 according to the first example embodiment of the disclosed subject matter will be described using FIG. 2. The control list 101 holds a plan of combination of functional elements which indicates which functional element should be carried out as to an external request or an execution result of a functional element. For example, the control list 101 holds a plan in which functional elements a, b and c are arranged in series as indicated by the arrows of solid lines of FIG. 2. This plan is called a plan 1. In the plan 1, it has been decided that, when the functional element a is carried out, the functional element b is carried out next. Determination of Yes/No is output from the functional element b, and, in the case of Yes, the functional element c is carried out next, and it has been decided that, in the case of No, the functional element c ends without being carried out.

Operations when carrying out the plan 1 of FIG. 2 will be described. When an execution request of the functional element a is received from outside or an execution request of service including the functional elements a, b and c is received from outside as an external request, the control unit 102 refers to the control list 101 and determines the functional element a as a functional element to be carried out next. Also, when an execution result of the functional element a is received, the control unit 102 refers to the control list 101 and determines the functional element b as a functional element to be carried out next. When a result of Yes is received from the functional element b, the control unit 102 refers to the control list 101 and determines the functional element c as a functional element to be carried out next.

The activation level calculation unit 106 can update the control list 101. For example, as indicated by the arrow of a dotted line of FIG. 2, it can be changed to a plan in which the functional element b is skipped without being carried out, and the functional element c is carried out next to the functional element a. The plan after this change is called a plan 2.

Operations when carrying out the plan 2 of FIG. 2 will be described. When, as an external request, an execution request of the functional element a is received from outside or an execution request of service including the functional elements a, b and c is received from outside, the control unit 102 refers to the control list 101 and determines the functional element a as a functional element to be carried out next. Also, when an execution result of the functional element a is received, the control unit 102 refers to the control list 101 and determines the functional element c as a functional element to be carried out next.

Here, a determination technique of whether to change the plan 1 to the plan 2 will be described. The activation level calculation unit 106 performs change of a plan based on an activation level of the functional element c. As an activation level of the functional element c, for example, the activation level calculation unit 106 calculates an execution frequency of the functional element c. Then, the activation level calculation unit 106 performs determination of whether the plan 1 is changed to the plan 2 based on the execution frequency of the functional element c. Specifically, the activation level calculation unit 106 calculates, using the execution frequency of the functional element c and the execution times of the functional element b and c, an average execution time of the plan 1 and an average execution time for carrying out the plan 2 with a probability x. Here, let the probability x be an execution frequency of the functional element c. Since the functional element c is carried out next when the functional element b outputs Yes, the probability x can also be called a probability of the functional element b outputting Yes. Let the average execution time to carry out the plan 2 with the probability x be an average execution time when carrying out the plan 1 with the probability of 1−x, and carrying out the plan 2 with the probability x. Then, when an average execution time to carry out the plan 2 with the probability x becomes shorter than an average execution time of the plan 1, change to the plan 2 from the plan 1 is performed.

Here, a calculation technique when, as the probability x, a probability that the functional element b outputs Yes is employed will be described. The monitoring and recording unit 105 monitors whether an output of the functional element b is Yes or whether it is No as an execution result of the functional element b by the execution unit 103. In addition, the monitoring and recording unit 105 records, as to one external request, information which can distinguish whether an output of the functional element b is Yes or No. The activation level calculation unit 106 receives the information and distinguishes whether an output of the functional element b is Yes or No for each external request. Then, the activation level calculation unit 106 calculates a probability that the functional element b outputs Yes from the number of times of the external requests and the number of times that an output of the functional element b has been Yes. Meanwhile, it may be such that the monitoring and recording unit 105 records the number of times of external requests and the number of times that an output of the functional element b has been Yes, and the activation level calculation unit 106 receives such information and calculates a probability that the functional element b outputs Yes.

Next, an average execution time of a plan will be described using FIG. 3. The solid line of FIG. 3 indicates relation between x and an average execution time of the plan 1. The dotted line of FIG. 3 indicates relation between x and an average execution time to carry out the plan 2 with the probability x. Here, for illustrative purposes, execution times of the functional elements b and c are set to T_b=10 seconds and T_c=20 seconds, respectively. In addition, the functional element b outputs Yes or No in response to the environment in which the node is arranged.

Although an average execution time of the plan 1 is close to T_b when x is close to 0, in other word, when a probability that the functional element b outputs No is high, an average execution time of the plan 1 increases when a probability of Yes becomes high (x approaches 1). In the case of the example shown in FIG. 3, when x exceeds ½, an average execution time to carry out the plan 2 with the probability x becomes shorter than the average execution time of the plan 1. Given that an average execution time of the plan 1 is T1 and an average execution time to carry out the plan 2 with the probability x is T2, T1 and T2 can be calculated by the following equations.

T1=(1−x)*T_b+x*(T_b+T_c)=T_c*x+T_b

T2=(1−x)(T_c*x+T_b)+x*T_c=−T_c*x̂2+(−T_b+2T_c)*x+T_b

In the above equations, T1>T2 is satisfied when x>1−T_b/T_c. In other words, when x exceeds a threshold value of 1−T_b/T_c, an average execution time to carry out the plan 2 with the probability x becomes shorter than an average execution time of the plan 1. Therefore, in the present case, when x exceeds a threshold value of 1−T_b/T_c, the activation level calculation unit 106 performs change to the plan 2 from the plan 1. As a result, an average execution time can be reduced.

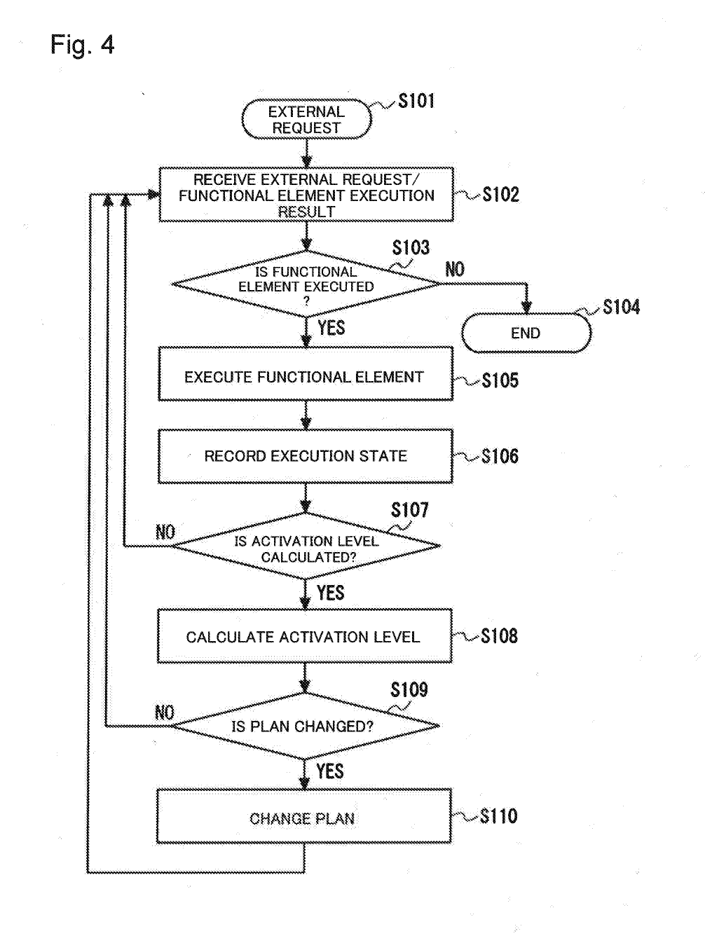

Next, processing of a service control device according to the first example embodiment of the disclosed subject matter will be described using the flow chart of FIG. 4. First, as an external request, an execution request of a functional element from outside or an execution request of service including a plurality of functional elements from outside occurs (S101). The external request may be any kind of request if it is a request from the outside of the service control device 100. For example, the external request may be an external request which occurs in the node having the service control device 100 or may be an external request which occurs in another node. As an external request, a functional element by initial setting at the time when the node having the service control device 100 is activated may be requested.

Next, the control unit 102 receives an external request or an execution result of a functional element (S102). In S102, the external request is received when the step is performed following S101. Also in S102, when the step is performed after execution of a functional element, an execution result of the functional element is received.

Next, the control unit 102 refers to the control list 101 and determines whether the next functional element is carried out or not (S103). In S103, when being determined that the next functional element is not carried out, execution of service including a plurality of functional elements which starts with the external request is ended (S104). As an example in which it is determined that the next functional element is not carried out, there is a case where an execution result of the functional element c in FIG. 2 is received or a case where an execution result of the functional element b is No.

In S103, when being determined that the next functional element is carried out, the execution unit 103 carries out the next functional element (S105). Execution of a functional element by the execution unit 103 is performed by receiving a direction of a functional element to be executed next from the control unit 102. The direction of a functional element to be executed next is performed by the control unit 102 determining a functional element to be carried out next with reference to the control list 101. The execution unit 103 outputs an execution result of the functional element to the control unit 102.

Next, the monitoring and recording unit 105 monitors and records an execution state of the functional element by the execution unit 103 (S106). Here, an execution state of a functional element is an execution result of the functional element, an execution time of the functional element and information on whether a specific functional element has been carried out. Meanwhile, an execution result of a functional element and information on whether a specific functional element has been carried out is information needed for calculating an execution frequency of the functional element c, for example, as an activation level of a functional element, and at least either one of them should be watched and recorded.

Next, the activation level calculation unit 106 determines whether an activation level based on the execution state of the functional element is calculated or not (S107). Although an activation level may be calculated every time one functional element is carried out, it may be calculated every time functional elements of a fixed number are carried out or at regular time intervals.

When, in S107, it is determined to calculate an activation level, the activation level calculation unit 106 calculates an activation level of the functional element based on the execution state of the functional element (S108). For example, as an activation level of a functional element, an execution frequency of the functional element c is calculated. When it is determined, in S107, not to calculate an activation level, the processing returns to S102 and the control unit 102 performs processing based on the execution result of the functional element output from the execution unit 103 in S105.

After S108, the activation level calculation unit 106 determines whether the plan of combination of functional elements which the control list 101 holds is changed or not based on the activation level of the functional element (S109). For example, the activation level calculation unit 106 calculates an average execution time of a plan of combination of functional elements which the control list 101 holds using the execution frequency of the functional element c and the execution time of the functional elements. Then, when an average execution time becomes short by changing the plan, it is determined to change the plan.

When, in S109, it is determined that the plan of combination of functional elements is changed, the activation level calculation unit 106 changes the plan of combination of functional elements which the control list 101 holds (S110). In S109, when being determined that the plan of combination of functional elements is not changed, the processing returns to S102 and the control unit 102 performs processing based on the execution result of the functional element output from the execution unit 103 in S105.

After S110, the processing returns to S102, and the control unit 102 performs processing based on the execution result of the functional element output from the execution unit 103 in S105.

Next, a specific example of the first example embodiment will be described. This specific example is an example in which a mobile device such as a smart phone and the like has a service control device according to this example embodiment, and detects a mobile object such as a person and an animal and the like. Meanwhile, a mobile device having a service control device according to this example embodiment may be a feature phone (e.g. folding cellular phone), a Tablet Personal Computer (PC) and a portable computer and the like. In addition, a service control device according to this example embodiment may be possessed by a device except for a mobile device. For example, it may be such that a service control device according to this example embodiment is possessed by an IoT device, a base station and an access point.

The functional element a performs processing to sense a mobile object simply by a sensor module of low power consumption such as an infrared sensor and a vibration sensor provided in the mobile device. In this processing, the processing time is short, but the accuracy of detection is not good. The functional element b extracts a feature quantity based on sensing data of such as an acceleration sensor and the like to detect a target object. In this processing, the processing time and the accuracy of detection is of a medium degree. The functional element c detects a target object from a camera image. In this processing, although the power consumption is high and the processing time is long, the detection accuracy is high.

Here, let an output when, by the functional element b, a feature quantity can be extracted and a target object can be detected be Yes, and an output when it cannot be detected be No. For example, in an environment with a lot of disturbance, an output of the functional element b will be No. In the case of an output of the functional element b being Yes, the functional element c is carried out, and, in the case of an output of the functional element b being No, the processing ends without carrying out the functional element c. When a probability that the functional element b outputs Yes is higher than a threshold value, the functional element b is skipped without being carried out, and the plan of combination of functional elements is changed in such a way that the functional element c is carried out following the functional element a. Meanwhile, a threshold value to be compared with a probability that the functional element b outputs Yes is calculated using an average execution time of a plan, for example.

In this specific example, in an environment with a lot of disturbance, since the functional element c that is of a high load is not operated unnecessarily, an average resource consumption can be suppressed. In addition, when there is little disturbance and the functional element b always outputs Yes, the plan is changed so as not to carry out the functional element b, and thus processing time of the functional element b can be omitted.

As it has been described above, in the service control device 100 according to the first example embodiment of the disclosed subject matter, by calculating an activation level of a functional element based on an execution state of the functional element and updating the control list 101 based on the activation level, combination of functional elements suitable for the environment in which the node having the service control device 100 is arranged can be realized, and therefore shortening of the response time of service to be provided and saving of the processing time and the resource consumption can be made.

In addition, by calculating an average execution time of a plan of combination of functional elements using an activation level of a functional element and an execution time of functional elements, and by updating the control list 101 when an average execution time becomes short by update of the control list 101, an average execution time of a plan can be reduced.

### Second Example Embodiment

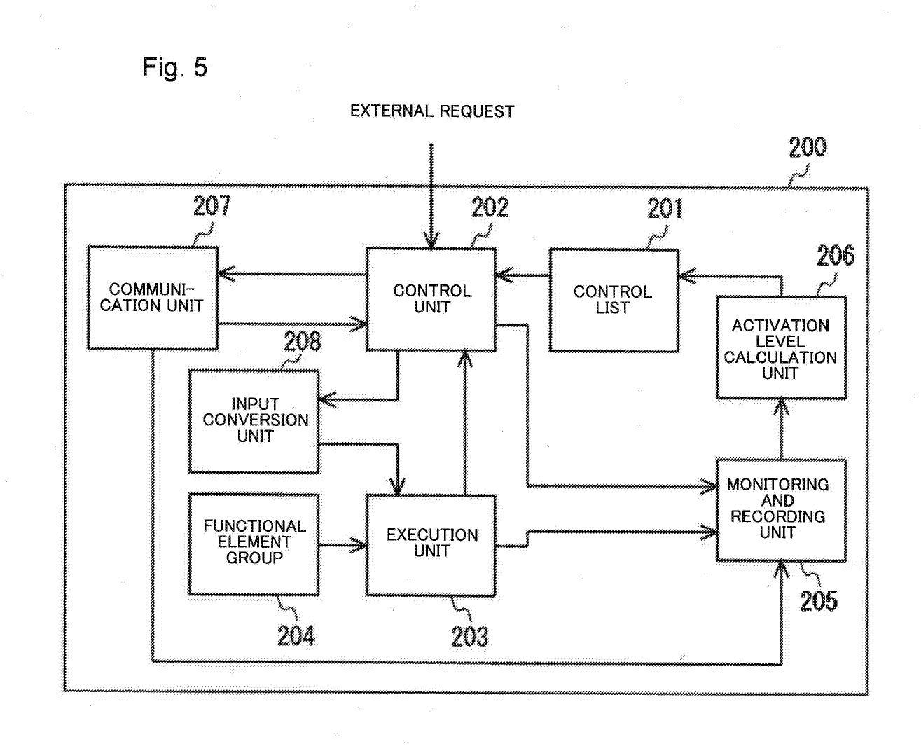

Next, a configuration of a service control device 200 according to a second example embodiment of the disclosed subject matter will be described using FIG. 5. The service control device 200 includes a control list 201, a control unit 202, an execution unit 203, a functional element group 204, a monitoring and recording unit 205, an activation level calculation unit 206, a communication unit 207 and an input conversion unit 208.

The control list 201 holds a plan of combination of functional elements. The control list 201 also holds information on whether conversion of an input by the input conversion unit 208 is needed. The control list 201 also holds information on whether a functional element is carried out by the local node. It will be explained in detail later about a plan of combination of functional elements which the control list 201 holds.

The control unit 202 receives an external request or an execution result of a functional element by the execution unit 203. Here, the external request includes an external request which occurs in the node having the service control device 200 and an external request received from the communication unit 207. An external request may be an execution request of a functional element from outside and an execution request of service including a plurality of functional elements from outside. An external request and an execution result of a functional element by the execution unit 203 that have been received are called an input signal to the control unit 202.

The control unit 202 refers to the control list 201 and determines a functional element to be carried out next as to an input signal to the control unit 202. The control unit 202 refers to the control list 201 and determines whether a conversion of an input is needed for an input to a functional element to be carried out next. It will be described in detail later about a conversion of an input. Then, the control unit 202 supplies a direction of a functional element to be executed next, an input signal to the control unit 202 and a direction of whether a conversion of an input is needed to the input conversion unit 208.

The control unit 202 refers to the control list 201 and also determines whether the next functional element is carried out by another node. When determining that the next functional element is carried out by another node, the control unit 202 generate an external request to request execution of the functional element. Then, the control unit 202 supplies the generated external request and information indicating a node which carries out the next functional element to the communication unit 207.

The input conversion unit 208 receives a direction of a functional element to be executed next, an input signal to the control unit 202 and a direction of whether a conversion of an input is needed from the control unit 202. When a conversion of an input is not needed, the input conversion unit 208 learns relation of input signals to the control unit 202. Learning of relation of input signals will be explained in detail later.

When conversion of an input is needed, the input conversion unit 208 converts the received input signal to the control unit 202 into an input signal to the functional element to be carried out next using relation of input signals to the control unit 202 obtained from learning in the past.

Then, the input conversion unit 208 supplies the direction of a functional element to be executed next to the execution unit 203. When conversion of an input has been performed, the input conversion unit 208 supplies, together with the direction of a functional element to be executed next, the input signal to the functional element to be carried out next to the execution unit 203.

The execution unit 203 receives the direction of the functional element to be executed next from the input conversion unit 208. The functional element group 204 is holding a plurality of functional elements. The execution unit 203 selects the functional element to be carried out next from the functional element group 204 based on the direction of the functional element to be executed next. The execution unit 203 carries out the selected functional element. When the input signal to the functional element to be carried out next is received from the input conversion unit 208, the execution unit 203 carries out the selected functional element using that input signal. The execution unit 203 outputs an execution result of the functional element to the control unit 202.

The communication unit 207 receives an external request which occurs in another node. Then, the communication unit 207 outputs the received external request to the control unit 202. Also, the communication unit 207 receives an external request generated by the control unit 202 and information which indicates a node which carries out the next functional element. The communication unit 207 transmits the external request received from the control unit 202 to the node which carries out the next functional element.

The monitoring and recording unit 205 monitors and records a time taken by communication by the communication unit 207, power consumption needed for execution of a functional element by the execution unit 203 and for communication by the communication unit 207, in addition to an execution state of the functional element by the execution unit 203. Then, the monitoring and recording unit 205 outputs the execution state of the functional element, the time taken for communication and the power consumption taken for execution of the functional element and for communication having been recorded to the activation level calculation unit 206.

The activation level calculation unit 206 receives the execution state of the functional element, the time taken for communication and the power consumption taken for execution of the functional element and for communication from the monitoring and recording unit 205. The activation level calculation unit 206 calculates an activation level of the functional element based on the execution state of the functional element. As an activation level of a functional element, the activation level calculation unit 206 calculates an execution frequency of a specific functional element. The calculation technique of the execution frequency is similar to that of the first example embodiment.

The activation level calculation unit 206 determines whether the control list 201 is updated based on the calculated activation level of the functional element. The determination of whether the control list 201 is updated or not may be performed, for example, by calculating an average execution time of a plan of combination of functional elements using an activation level of a functional element and an execution time of a functional element including a communication time, and by determining whether the average execution time becomes short by the update of the control list 201. In addition, it may be performed by calculating average power consumption of a plan of combination of functional elements using an activation level of a functional element and power consumption taken for execution of a functional element and communication, and by determining whether average power consumption becomes small by the update of the control list 201. It may be determined that the control list 201 is updated when an average execution time becomes short and, in addition, average power consumption becomes small.

When it is determined that the control list 201 is updated, the activation level calculation unit 206 updates the control list 201. In other words, the plan of combination of functional elements which the control list 201 holds is changed. It will be explained in detail later about processing of the activation level calculation unit 206.

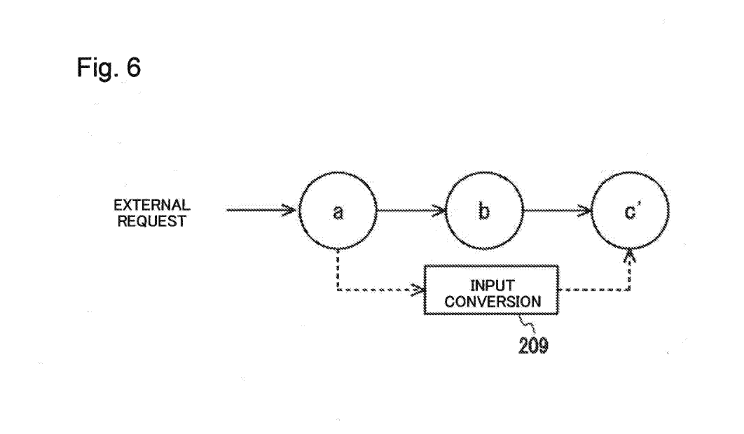

Next, a plan of combination of functional elements which the control list 201 according to the second example embodiment of the disclosed subject matter holds will be described using FIG. 6. The control list 201 holds a plan of combination of functional elements that indicates which functional element should be carried out as to an external request or an execution result of a functional element. For example, the control list 201 holds a plan in which functional elements a, b and c′ are arranged in series as indicated by the arrows of solid lines of FIG. 6. This plan is called a plan 3. In the plan 3, it has been decided whether the functional element c′ is carried out by the local node or carried out by another node. The plan 3 is similar to the plan 1 of the first example embodiment besides that. Here, another node is an edge node different from the edge node by which the functional elements a and b are carried out, or it is a server or the like.

The activation level calculation unit 206 can update the control list 201. For example, as indicated by the arrows of dotted lines of FIG. 6, it can be changed to a plan in which an output of the functional element a is input to the functional element c′ via input conversion 209. The plan after this change is called a plan 4.

Next, using FIG. 6, description will be made about information on whether conversion of an input is needed or not that is held in the control list 201. When an output of a functional element is input to the next functional element without interposing the input conversion 209, a conversion of an input is not necessary. In other words, conversion of an input is not necessary because the arrows of the solid lines in the plan 3 are made respectively enter to the next functional elements without interposing the input conversion 209. When an output of a functional element is input to the next functional element via the input conversion 209, conversion of the input is required. In other words, conversion of an input is needed because an output of the functional element a in the plan 4 is input to the functional element c′ via the input conversion 209.

Next, operations when carrying out the plan 3 of FIG. 6 will be described. When an execution request of the functional element a from outside or an execution request of service including the functional elements a, b and c′ from outside is received as an external request, the control unit 202 refers to the control list 201 and determines the functional element a as a functional element to be carried out next. Then, the control unit 202 supplies a direction of the functional element a to be executed next, and a direction which indicates that conversion of an input is not needed to the input conversion unit 208. When an execution result of the functional element a is received, the control unit 202 refers to the control list 201 and determines the functional element b as a functional element to be carried out next. Then, the control unit 202 supplies to the input conversion unit 208 a direction of the functional element b to be executed next, the execution result of the functional element a and a direction which indicates that conversion of an input is not needed. When a result of Yes is received from the functional element b, the control unit 202 refers to the control list 201 and determines the functional element c′ as a functional element to be carried out next. The control unit 202 refers to the control list 201 and determines whether the functional element c′ is carried out by another node or not. Then, when it is determined that the functional element c′ is carried out in another node, the control unit 202 generates an external request to request execution of the functional element c′. Then, the generated external request and information indicating a node which carries out the functional element c′ is supplied to the communication unit 207. Also, when it is determined that the functional element c′ is carried out by the local node not by another node, the control unit 202 supplies to the input conversion unit 208 a direction of the functional element c′ to be carried out next, the execution result of the functional element b and a direction indicating that conversion of an input is not needed.

Next, operations when carrying out the plan 4 of FIG. 6 will be described. When an execution request of the functional element a from outside or an execution request of service including the functional elements a, b and c′ from outside is received as an external request, the control unit 202 refers to the control list 201 and determines the functional element a as a functional element to be carried out next. Then, the control unit 202 supplies a direction of the functional element a to be executed next, and a direction which indicates that conversion of an input is not needed to the input conversion unit 208. Also, when an execution result of the functional element a is received, the control unit 202 refers to the control list 201 and determines the functional element c′ as a functional element to be carried out next. The control unit 202 refers to the control list 201 and determines whether the functional element c′ is carried out by another node. Then, when it is determined that the functional element c′ is carried out by another node, the control unit 202 generates an external request to request execution of the functional element c′. Then, the generated external request and information indicating a node which carries out the functional element c′ is supplied to the communication unit 207. When it is determined that the functional element c′ is carried out by the local node, the control unit 202 supplies a direction of the functional element c′ to be carried out next, the execution result of the functional element a and a direction which indicates that conversion of an input is needed to the input conversion unit 208. Meanwhile, when, in the plan 3 and 4 of FIG. 6, an external request of the functional element c′ is received from the communication unit 207, the control unit 202 refers to the control list 201 and determines the functional element c′ as a functional element to be carried out next. In this case, it is determined that the functional element c′ is carried out by the local node.

Next, using FIG. 6, learning of relation of input signals to the control unit 202 will be described. This learning is performed when conversion of an input is not needed. Learned information is used when input conversion is performed later. For example, out of combination of functional elements of no smaller than 2 which starts from input of an execution result of a functional element, relation between an input of an execution result of the first functional element and an input to the last functional element is learned. Specifically, when an execution result of the functional element a is input to the control unit 202, and, after that, an execution result of the functional element b is input to the control unit 202, supplied to the input conversion unit 208 are an execution result of the functional element a and a direction which indicates that conversion of an input is not necessary, and, after that, an execution result of the functional element b and a direction which indicates that conversion of an input is not needed. The input conversion unit 208 learns relation between an execution result of the functional element a and an execution result of the functional element b from this supplied information.

Next, conversion of an input will be described using FIG. 6. The input conversion is performed in order to make an input to the functional element c′, that is, an output of the functional element b in the arrow of a solid line and an output of the input conversion 209 in the arrow of a dotted line be a similar content. For this, input conversion is performed using the above learned relation. For example, when, out of a combination of functional elements of no smaller than 2 which starts from input of an execution result of a functional element, an input of an execution result of the first functional element is input to the last functional element directly, the input of the execution result of the first functional element is converted into a corresponding input to the last functional element using the relation learned in the past. Specifically, the input conversion unit 208 converts, using the relation between an execution result of the functional element a and an execution result of the functional element b learned in the past, an execution result of the functional element a into an execution result of the functional element b. Then, the execution result of the functional element b after the conversion is made to be an input signal to the functional element c′.

Here, the determination technique of whether change to the plan 4 from the plan 3 is performed or not will be described. The activation level calculation unit 206 performs change of a plan based on an activation level of the functional element c′. As an activation level of the functional element c′, for example, the activation level calculation unit 206 calculates an execution frequency of the functional element c′. Then, the activation level calculation unit 206 carries out determination of whether change to the plan 4 from the plan 3 is performed or not based on the execution frequency of the functional element c′. Specifically, when the functional element c′ is carried out by the local node, the activation level calculation unit 206 calculates an average execution time of the plan 3 and an average execution time to carry out the plan 4 with the probability x using the execution frequency of the functional element c′ and execution times of the functional elements b and c′. Here, the probability x is made to be an execution frequency of the functional element c′. Since the functional element c′ is carried out next when the functional element b outputs Yes, the probability x can also be called a probability that the functional element b outputs Yes. The average execution time to carry out the plan 4 with the probability x is made to be an average execution time when carrying out the plan 3 with the probability 1−x, and carrying out the plan 4 with the probability x. Then, when an average execution time to carry out the plan 4 with the probability x becomes shorter than an average execution time of the plan 3, change to the plan 4 from the plan 3 is made. Meanwhile, an average execution time of a plan when the functional element c′ is carried out by the local node can be calculated in a similar way to the first example embodiment.

When the functional element c′ is carried out by another node, the activation level calculation unit 206 calculates, using an execution frequency of the functional element c′, an execution time of the functional element b and an execution time of the functional element c′ including a communication time, an average execution time of the plan 3 and an average execution time to carry out the plan 4 with the probability x. Also, when the functional element c′ is carried out by another node, the activation level calculation unit 206 calculates, using the execution frequency of the functional element c′, electric power taken for execution of the functional element b and power consumption taken for communication of the functional element c′, average power consumption of the plan 3 and average power consumption to carry out the plan 4 with the probability x. Then, when the average execution time to carry out the plan 4 with the probability x becomes shorter than the average execution time of the plan 3, and, in addition, the average power consumption to carry out the plan 4 with the probability x becomes smaller than the average power consumption of the plan 3, change to the plan 4 from the plan 3 is made. It may be also such that, when either of the condition of an average execution time and the condition of average power consumption is satisfied, change to the plan 4 from the plan 3 is made.

An average execution time and average power consumption in a case where the functional element c′ of FIG. 6 is carried out in another node will be described. Given that an average execution time of the plan 3 is T3, an average execution time to carry out the plan 4 with the probability x is T4, average power consumption of the plan 3 is P3, average power consumption to carry out the plan 4 with the probability x is P4, an execution time of the functional element b is T_b, an execution time of the functional element c′ including a communication time is T_c′, power consumption taken for carrying out the functional element b is P_b, and power consumption taken for communication of the functional element c′ is P_c′, T3, T4, P3 and P4 can be calculated by the following equations, respectively.

T3=(1−x)*T_b+x*(T_b+T_c′)=T_c′*x+T_b

T4=(1−x)(T_c′*x+T_b)+x*T_c′=−T_c′*x̂2+(−T_b+2T_c′)*x+T_b

P3=(1−x)*P_b+x*(P_b+P_c′)=P_c′*x+P_b

P4=(1−x)(P_c′*x+P_b)+x*P_c′=−P_c′*x̂2+(−P_b+2P_c′)*x+P_b

In the above-mentioned Formula, T3>T4 is satisfied when x>1−T_b/T_c′. In other words, when x exceeds a threshold value as 1−T_b/T_c′, an average execution time to carry out the plan 4 with the probability x becomes shorter than an average execution time of the plan 3.

Also, in the above equations, P3>P4 is filled when x>1−P_b/P_c′. In other words, when x exceeds a threshold value as 1−P_b/P_c′, average power consumption to carry out the plan 4 with the probability x becomes smaller than average power consumption of the plan 3.

Therefore, in the case of this example, when both of that x exceeds a threshold value as 1−T_b/T_c′ and that x exceeds a threshold value as 1−Pb/P_c′ are satisfied, or either one of them is satisfied, the activation level calculation unit 206 performs change to the plan 4 from the plan 3. As a result, at least either one of an average execution time and average power consumption can be reduced.

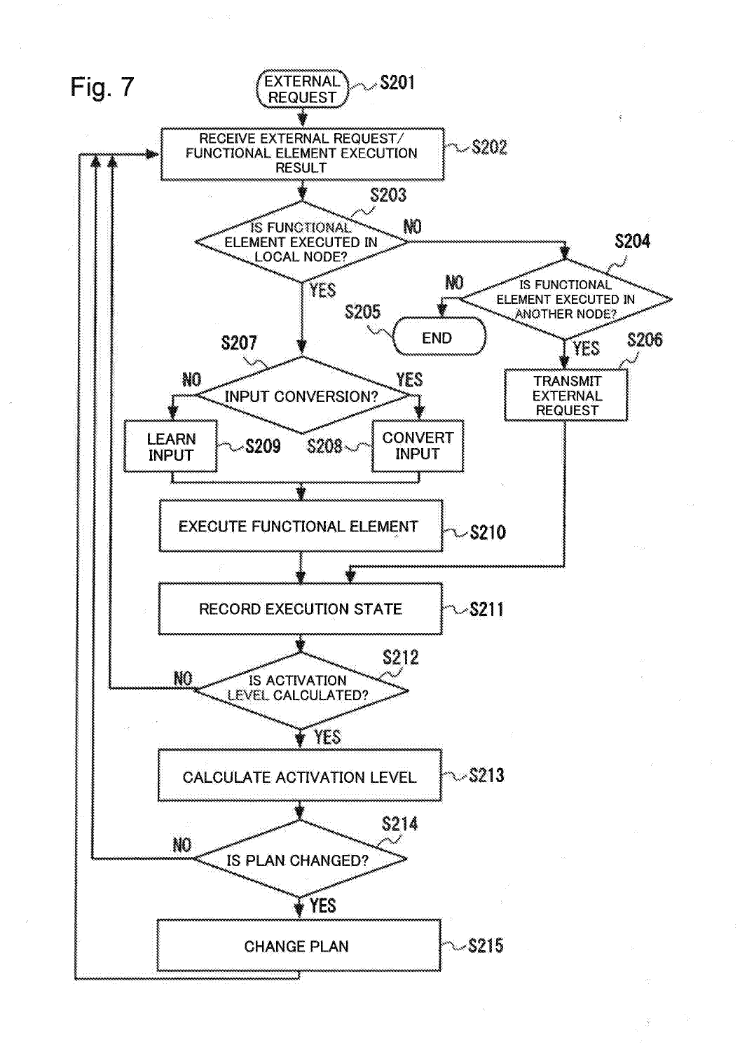

Next processing of the service control device according to the second example embodiment of the disclosed subject matter will be described using the flow chart of FIG. 7. First, as an external request, an execution request of a functional element from outside or an execution request of service including a plurality of functional elements from outside occurs (S201).

Next, the control unit 202 receives an external request or an execution result of a functional element (S202). In S202, when the step is performed following S201, the external request is received. Also, in S202, when the step is performed after execution of a functional element, an execution result of the functional element is received.

Next, the control unit 202 refers to the control list 201 and determines whether the next functional element is carried out by the local node (S203). When, in S203, it is determined that the next functional element is not carried out by the local node, it is determined whether the next functional element is carried out by another node (S204). When being determined by S204 that the next functional element is not carried out even in another node, execution of the service including a plurality of functional elements which start with the external request is ended (S205). Here, as an example being determined that the next functional element is not carried out even in another node, a case where an execution result of the functional element c′ in FIG. 6 is received, a case where an execution result of the functional element b is No and the like are cited.

When being determined by S204 that the next functional element is carried out by another node, an external request is generated, and the generated external request is transmitted to the other node by the communication unit 207 (S206). Here, as an example determined that the next functional element is carried out by another node, there is a case where, in FIG. 6, the next functional element is the functional element c′ and it has been decided in advance that the functional element c′ is carried out by another node.

When being determined by S203 that the next functional element is carried out by the local node, the control unit 202 refers to the control list 201 and determines whether conversion of an input to the next functional element is needed or not (S207). When being determined by S207 that conversion of an input is required, the input conversion unit 208 converts the input (S208). When being determined by S207 that conversion of an input is not necessary, the input conversion unit 208 performs learning of relation between input signals to the control unit 202 (S209).

After S208 or S209, the execution unit 203 carries out the next functional element (S210). Execution of a functional element by the execution unit 203 is performed by receiving a direction of a functional element to be executed next from the input conversion unit 208. The direction of a functional element to be executed next is performed in such a way that the control unit 202 determines a functional element to be carried out next with reference to the control list 201. When conversion of an input by the input conversion unit 208 has been performed, the execution unit 203 carries out the functional element using the input signal to the functional element to be carried out next received from the input conversion unit 208. Furthermore, the execution unit 203 outputs an execution result of the functional element to the control unit 202.

Next, the monitoring and recording unit 205 monitors and records an execution state of the functional element by the execution unit 203, the time taken for communication by the communication unit 207 and the power consumption taken for execution of the functional element by the execution unit 203 and for communication by the communication unit 207 (S211). In S211, when it is performed following S210, an execution state of the functional element by the execution unit 203 and the power consumption taken for carrying out the functional element by the execution unit 203 is monitored and recorded. In S211, when performing the step following S206, the time taken for communication by the communication unit 207 and the power consumption taken for communication by the communication unit 207 is monitored and recorded.

Next, the activation level calculation unit 206 determines whether an activation level based on an execution state of a functional element is calculated (S212). Although the activation level may be calculated every time one functional element is carried out, it may be calculated every time a fixed number of functional elements are carried out or, at regular time intervals.

When it is determined that an activation level is calculated in S212, the activation level calculation unit 206 calculates an activation level of a functional element based on an execution state of the functional element (S213). For example, an execution frequency of the functional element c′ is calculated as an activation level of a functional element. When being determined that an activation level is not calculated in S212, the processing returns to S202 and the control unit 202 performs processing based on the execution result of the functional element output from the execution unit 203 in S210.

After S213, the activation level calculation unit 206 determines whether the plan of combination of functional elements which the control list 201 holds is changed or not based on the activation level of the functional element (S214). For example, when the functional element c′ is carried out by another node, an average execution time of the plan of combination of functional elements which the control list 201 holds is calculated using the execution frequency of the functional element c′, the execution time of the functional element b and the execution time of the functional element c′ including the communication time. Then, when an average execution time becomes short by changing the plan, it is determined to change the plan. Also, when the functional element c′ is carried out by another node, it may be such that average power consumption of the plan of combination of functional elements which the control list 201 holds is calculated using the execution frequency of the functional element c′, the electric power taken for execution of the functional element b and the power consumption taken for communication of the functional element c′, and, when the average power consumption becomes small by changing the plan, it is determined to change the plan. Furthermore, it may be determined to change the plan when an average execution time becomes short and, in addition, average power consumption becomes small by changing the plan.

When being determined that the plan of combination of functional elements is changed in S214, the activation level calculation unit 206 changes the plan of combination of functional elements which the control list 201 holds (S215). When being determined that the plan of combination of functional elements is not changed in S214, the processing returns to S202 and the control unit 202 performs processing based on the execution result of the functional element output from the execution unit 203 in S210.

The processing returns to S202 after S215, and the control unit 202 performs processing based on the execution result of the functional element output from the execution unit 203 in S210.

Meanwhile, in the above-mentioned example, although it has been illustrated that an external request generated in the communication unit 207 is transmitted, without limited to this, the communication unit 207 may transmit an input signal converted by the input conversion unit 208 as well as the generated external request.

Next, a specific example of the second example embodiment will be described. This specific example is an example in which, by making the service control device 200 according to this example embodiment have an IoT device such as a sensor node, for example, and an animal is detected. The functional element a performs detection with a low load and low accuracy by an infrared sensor and a vibration sensor as is the case with the specific example of the first example embodiment. The functional element b performs detection with a medium load and medium accuracy by an acceleration sensor and the like. It is supposed that the functional element b even distinguishes and outputs a classification of a detection target. The functional element c′ is detection using an image specialized in an input classification.

It is supposed that the output when a classification of a detection target has been able to be distinguished by the functional element b is set to Yes, and the output when the classification has not been able to be distinguished is set to No. When an output of the functional element b is Yes, the functional element c′ is carried out, and, when an output of the functional element b is No, the processing ends without carrying out the functional element c′. When a probability that the functional element b outputs Yes is higher than a threshold value, the plan of combination of functional elements is changed in such a way that the functional element b is skipped without being carried out, and the functional element c′ is carried out next to the functional element a. Meanwhile, it is supposed that a threshold value for comparing with a probability of the functional element b outputting Yes is calculated using an average execution time of a plan.

When the functional element b is carried out next to the functional element a, an input conversion unit provided in the IoT device learns relation between a detection result of the functional element a and a classification distinguished by the functional element b. In addition, when the functional element c′ is carried out next to the functional element a, the input conversion unit converts the detection result of the functional element a into a classification based on learning using the relation obtained from learning in the past. Then, the classification based on learning after the conversion is input to the functional element c′.

In this specific example, when, in an actual environment, the classification of a detection target can be always distinguished by the functional element b, that is, when the functional element b always outputs Yes, the plan is changed so as not to carry out the functional element b, and, therefore, the processing time of the functional element b can be omitted. In addition, even when the functional element b is not carried out, a correct result similar to the case when the functional element b is carried out can be obtained because a detection result of the functional element a is converted into a classification based on learning and input to the functional element c′.

Also, by the functional element b, it is possible to set an output when a distinguished classification of a detection target is a specific classification to Yes, and set an output besides that to No. In this case, when the functional element c′ is carried out next to the functional element a, the input conversion unit converts a detection result of the functional element a into a specific classification based on learning using the relation obtained from learning in the past. Then, the specific classification after the conversion is input to the functional element c′. This is effective when there are frequent appearances of only a specific classification in the actual environment.

The functional element c′ may be made to be carried out by another node such as a server. In this case, a threshold value used for comparison with a probability that the functional element b outputs Yes may be calculated using average power consumption of a plan. Also, the functional element b may perform, after identifying a detection classification, up to image compression specialized in the classification to output the compressed data. In this case, the input conversion unit provided in the IoT device may convert it into compressed data and output the data. Generally, it is preferable that a transfer data amount between nodes be small, and there is a possibility that a data volume can be reduced by identifying up to a detection classification to perform data compression specialized in the classification.

As it has been described above, in a service control device according to the second example embodiment of the disclosed subject matter, combination of functional elements suitable for an environment in which the node having the service control device 200 is arranged can be realized and shortening of a response time of service to be provided and saving in a processing time and resource consumption can be made, by calculating an activation level of a functional element based on an execution state of the functional element, and updating the control list 201 based on the activation level.

Also, an average execution time of a plan of combination of functional elements is calculated using an activation level of a functional element and an execution time of a functional element, and, when an average execution time becomes short by update of the control list 201, an average execution time of the plan can be reduced by updating the control list 201.

In addition, by performing input conversion when a plan which skips a certain functional element is executed, a correct result similar to that of the case where the functional element is not skipped can be obtained even for service for which a correct result may not be obtained when a certain functional element is skipped.

Further, by determining whether a plan is changed using an execution time of a functional element including a communication time, power consumption and the like taken for communication, a plan can be changed appropriately even if it is a plan to direct execution of a functional element to another node.

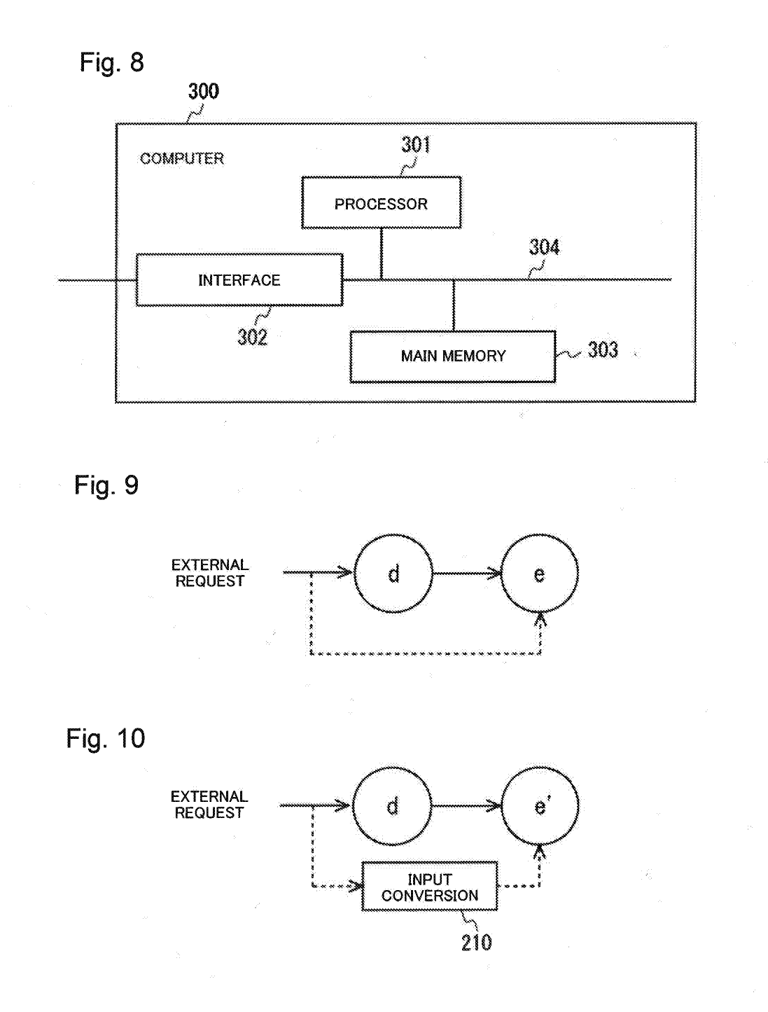

Meanwhile, the control lists 101 and 201, the control units 102 and 202, the execution units 103 and 203, the functional element groups 104 and 204, the monitoring and recording units 105 and 205, the activation level calculation units 106 and 206, the communication unit 207 and the input conversion unit 208 in each above-mentioned example embodiment are constituted using hardware such as Integrated Circuit (IC) and the like, software or a combination of the both. For example, the service control devices 100 and 200 are constituted using a general computer. FIG. 8 indicates a hardware exemplary configuration of a general computer 300.

The computer 300 includes a processor 301, an interface 302 and a main memory 303 connected via a bus 304.

The processor 301 executes a program stored in the main memory 303. The processor 301 inputs and outputs various kinds of information via the interface 302. The interface 302 is used by a data input/output means for exchange of data. The main memory 303 stores a program to be executed by the processor 301. In order to perform processing of each function unit, instruction groups to be made to be processed by the processor 301 are described in the stored program. Each function unit of the service control devices 100 and 200 can be realized by executing a program for processing of each function unit by the processor 301. For example, the control lists 101, 201, the functional element groups 104 and 204 are realized by the main memory 303. The control units 102 and 202, the execution units 103 and 203, the monitoring and recording units 105 and 205, the activation level calculation units 106 and 206, the communication unit 207 and the input conversion unit 208 can be realized by a program for processing of each function unit being executed by the processor 301.

This program is stored using various types of non-temporary computer readable media, and it can be supplied to the computer. A non-temporary computer readable medium includes various types of substantial recording media (tangible storage medium). An example of a non-temporary computer readable medium includes a magnetic recording medium (e.g. flexible disc, magnetic tape and hard disc drive), magneto-optic recording media (e.g. magneto-laser disc), a Compact Disc Read Only Memory (CD-ROM), a CD-R, CD-R/W and a semiconductor memory (e.g. mask ROM, PROM (Programmable ROM), EPROM (Erasable PROM), flash ROM and RAM (Random Access Memory)). A program may be supplied by various types of transitory computer readable medium to the computer. An example of the temporary computer readable medium includes an electric signal, a light signal and a radio wave. The temporary computer readable medium can supply a program to the computer via a wired communication path such as an electric wire and an optic fiber or a radio channel.

Meanwhile, the disclosed subject matter is not limited to the above-mentioned example embodiments, and it can be modified appropriately within a range that does not deviate from the gist. For example, a plan may be changed in such a way that a functional element of a high activation level may be carried out with priority.

Also, in the example embodiments, although a plan of a combination including three functional elements has been described, the number of functional elements may be of any number when it is a plan of combination including no smaller than two functional elements. For example, an example of a plan of combination including two functional elements d and e is shown in FIG. 9. In the plan indicated by the arrows of solid lines, when there is an external request, a functional element d is carried out, determination of Yes/No is output from the functional element d, and a functional element e is carried out next in the case of Yes, and, in the case of No, the processing ends without carrying out the functional element e. In the plan indicated by the arrows of dotted lines, when there is an external request, the functional element d is skipped without being carried out, and the functional element e is carried out directly. An example of a plan of combination including two functional elements d and e′ is indicated in FIG. 10. In this case, in the plan indicated by the arrows of dotted lines, input conversion is performed via input conversion 210. The input conversion is performed by converting an input of an external request into an output of the functional element d using relation obtained from learning in the past. In other words, the input of the external request is converted into an input of the functional element e′.

As above, the disclosed subject matter has been described taking the example embodiments mentioned above as an exemplary example. However, the disclosed subject matter is not limited to the example embodiments mentioned above. That is, various aspects which a person skilled in the art can understand can be applied to the disclosed subject matter within the scope of the disclosed subject matter.

This application claims priority based on Japanese application Japanese Patent Application No. 2015-118197 filed on Jun. 11, 2015, the disclosure of which is incorporated herein in its entirety by reference.

### REFERENCE SIGNS LIST

100, 200 Service control device
101, 201 Control list
102, 202 Control unit
103, 203 Execution unit
105, 205 Monitoring and recording unit
106, 206 Activation level calculation unit
207 Communication unit
208 Input conversion unit

1. A service control device comprising:
a controller that receives one of an external request and an execution result of a functional element and directs a functional element to be carried out next by referring to a control list holding a plan of combination of functional elements;
an execution unit configured to carry out the functional element directed by the controller;
a monitoring and recording unit configured to monitor means for monitoring an execution state of a functional element and record; and
an activation level calculation unit configured to calculate an activation level of a functional element based on the execution state of a functional element having been recorded and update the control list based on the activation level.

2. The service control device according to claim 1,
wherein the activation level calculating unit calculates an execution frequency of a specific functional element as the activation level by using a recorded execution state of the functional element, calculates an average execution time of the plan of combination of functional elements by using the activation level and an execution time of a functional element, and updates the control list when the average execution time becomes short by update of the control list.

3. The service control device according to claim 2, further comprising a communicator that transmits a direction of a functional element to be executed next to another node,
wherein the activation level calculating unit calculates an average execution time of the plan of combination of functional elements by using the activation level and the execution time of a functional element including a communication time by the communicator.

4. The service control device according to claim 3,
wherein the activation level calculating unit calculates average power consumption of the plan of combination of functional elements by using the activation level, power consumption taken for communication by the communication unit and power consumption taken for carrying out a functional element, and updates the control list when at least one of that the average power consumption becoming small and that the average execution time becoming short is satisfied by update of the control list.

5. The service control device according to claim 1, further comprising an input convertor that conversion means,
learns, among combination of two or more functional elements starting from one of the external request and the input of an execution result of a functional element, relation between a first input and an input to a last functional element of the combination of two or more functional elements, and converts the first input into a corresponding input to the last functional element using the relation when the first input is input to the last functional element directly.

6. A service control method comprising:
determining a functional element to be carried out next in response to one of an external request and an execution result of a functional element, by referring to a control list holding a plan of combination of functional elements;
carrying out the functional element to be carried out next having been determined;
monitoring an execution state of a functional element and recording;
calculating an activation level of a functional element based on a recorded execution state of the functional element; and
updating the control list based on the activation level.

7. The service control method according to claim 6,
wherein the calculating the activation level comprises
calculating an execution frequency of a specific functional element as the activation level, by using an recorded execution state of the functional element, and
calculating an average execution time of the plan of combination of functional elements, by using the activation level and an execution time of a functional element, and
wherein updating the control list when the average execution time becomes short by update of the control list.

8. The service control method according to claim 7, further comprising transmitting a direction of a functional element to be executed next to another node,
wherein average execution time of the plan of combination of functional elements is calculated using the activation level and the execution time of a functional element including a communication time by the transmitting.

9. The service control method according to claim 1, further comprising:
among combination of two or more functional elements starting from one of the external request and the input of an execution result of a functional element, learning relation between a first input and an input to a last functional element of the combination of two or more functional elements; and
converting the first input into a corresponding input to the last functional element using the relation when the first input is input to the last functional element directly.

10. A non-transitory computer readable recording medium storing a program to cause a computer execute:
determining a functional element to be carried out next in response to one of an external request and an execution result of a functional element, by referring to a control list holding a plan of combination of functional elements;
carrying out the functional element to be carried out next having been determined;
monitoring an execution state of a functional element and recording;
calculating an activation level of a functional element based on a recorded execution state of a functional element; and
updating the control list based on the activation level.
